(19) United States
(12) Patent Application Publication
(10) Pub. No.: US 2022/0209607 A1
(43) Pub. Date: Jun. 30, 2022

(54) ELECTRICAL MACHINE, AND DRIVE DEVICE FOR A MOTOR VEHICLE

(71) Applicant: JHEECO E-DRIVE AG, Eschen (LI)

(72) Inventors: Rene FRANCK, Sevelen (CH); Katja STENGERT, Lienz (CH); Martin STÖCK, Salez (CH); Andreas IWASCHTSCHENKO, Höchst (AT)

(21) Appl. No.: 17/601,408

(22) PCT Filed: Mar. 31, 2020
(86) PCT No.: PCT/EP2020/059083

§ 371 Date: Oct. 4, 2021

(30) Foreign Application Priority Data
Apr. 4, 2019 (DE) 10 2019 204 796.3

(51) Int. Cl. H02K 3/28; H02K 3/50; H02K 5/22

(52) U.S. Cl. CPC H02K 3/28; H02K 5/225; H02K 3/50

(57) ABSTRACT

The present invention relates to an electrical machine, in particular an electric motor, comprising a stator having a winding overhang, wherein: the winding overhang is equipped with at least one phase connection lug or star-point connection lug; a connection means is provided for electrically connecting the phase connection lug or star-point connection lug to a current source; the connection means comprises a first connection piece, which is connected to the phase connection lug or star-point connection lug and has a threaded bore; the connection means comprises a second connection piece, which is equipped with a bore; the first connection piece is integrally connected, in particular welded, to the phase connection lug or star-point connection lug in question, and the threaded bore of the first connection piece and the bore of the second connection piece have a common geometric axis; a screw is screwed through the bore of the second connection piece into the threaded bore of the first connection piece. The present invention further relates to a drive device, preferably for a motor vehicle, comprising a housing, in which an electrical machine, in particular an electric motor, is accommodated, characterized by an electrical machine according to at least one of the preceding claims.

The present application is the national stage of PCT Application No. PCT/EP2020/059083, filed on Mar. 31, 2020, which claims priority to the German patent application No. 102019204796.2, filed on Apr. 4, 2019, which are incorporated herein by reference in their entireties.

The present invention relates to an electrical machine, in particular an electric motor, and a drive device with an electrical machine, in particular an electric motor, preferably for a motor vehicle.

An electrical machine of the aforementioned type with an electrical connection means has become known, for example, from US2014062234 A1. It describes a connection means in which connection phases of the converter and connection phases of the motor winding are each screwed to conductive current bolts via cable lugs. The high assembly efforts are disadvantageous since the connection is effected by a double fastening per phase.

This is what the present invention addresses, which has the object of suggesting an improved electrical machine by which the above-outlined problems can be overcome. It is in particular the object of the present invention to provide an electrical machine, in particular electrical connection means, which is easier to assemble.

According to the invention, this object is achieved by an electrical machine having the characterizing features of claim 1. By a first connection piece being integrally connected, in particular welded, to a phase connection lug or star-point connection lug in question, and a threaded bore of the first connection piece and a bore of a second connection piece having a common geometric axis, wherein a screw is screwed through the bore of the second connection piece into the threaded bore of the first connection piece, assembly can essentially be facilitated since only one screw is required for the electric connection of the current source, in particular the converter, and the phase connection lug or star-point connection lug, and for fixing the connection means.

Further advantageous embodiments of the suggested invention in particular result from the features of the subclaims. The objects or features of the different claims can be basically realized individually or else be arbitrarily combined with each other.

The electric conductor and/or the connection piece and/or the phase connection lug and/or the star-point connection lug is preferably designed as a solid wire, for example as a copper rod. Thereby, they maintain their mechanical own stability which facilitates the assembling capability, e.g. by the connection pieces being able to be placed and welded in a mechanized manner.

In an advantageous embodiment of the invention, an electrically conductive sleeve is provided between the first connection piece and the second connection piece, the sleeve being in electric connection both with the first connection piece and the second connection piece. The sleeve can be the actual conductor and moreover the spacer between the two connection pieces. It is therefore even possible to employ a non-conductive screw. Via the sleeve, first and second connection pieces can be joined to each other under tension.

In a further advantageous embodiment of the invention, the second connection piece can comprise a rigid electric conductor (bus bar), in which the (open or closed) bore is introduced. A rigid electric conductor basically offers itself since here, a correspondingly oriented bore can be introduced. Basically, however, a flexible conductor, optionally with a cable lug, is also possible.

In a further advantageous embodiment of the invention, an insulating connection body can be provided for the connection means, wherein the connection means is received in the connection body at least in sections. The insulating connection body can in particular be used as a guide and seal of the connection means. For example, the connection means can be lead through from a space to which a cooling fluid is admitted to a space to which no cooling fluid is admitted. Furthermore, the connection means can be correspondingly guided and stabilized.

In a further advantageous embodiment of the invention, the first connection piece can have an angular cross-section, wherein a seat for the first connection piece in the connection body has an angular design. Thereby, for example, fastening moments can be guided from the first connection means to the connection body by interlocking them, and integral connections of the first connection element can be protected from the application of force.

In a further advantageous embodiment of the invention, the electrical machine may be equipped with four connection means which are received in the connection body at least in sections. Usually, the connection of three phases and one star point is required, so that it offers itself to receive the connection means in a compact connection body.

In a further advantageous embodiment of the invention, the screw may be equipped with a sealing means, in particular an O-ring. The sealing means can serve to further improve the sealing of a space to which a cooling fluid is admitted from a space to which no cooling fluid is admitted.

In a further advantageous embodiment of the invention, the sleeve may be equipped with a sealing means, in particular an O-ring. The sealing means can serve to further improve the sealing of a space to which a cooling fluid is admitted from a space to which no cooling fluid is admitted.

In a further advantageous embodiment of the invention, the threaded bore may be provided as a prefabricated threaded bore or as a threaded bore created during the fastening of a self-tapping screw, in particular a chiplessly self-tapping screw. By a chiplessly self-tapping screw, one production step can be omitted.

The screw can be self-locking, for example, by a variable thread lead. Thereby, a separate screw locking device can be omitted.

The connection piece is selected from a material advantageous for the purpose of application, in particular copper or aluminum. Aluminum can be particularly advantageously used, for example, for chipless fastening.

A further object of the present invention is to provide an improved compact drive device with an electrical machine. It is in particular an object of the present invention to provide an easily assembled drive device.

According to the invention, this object is achieved by a drive device having the characterizing features of claim 13. By an electrical machine according to at least one of the preceding claims being used in the drive device, the above-outlined advantages can be utilized for the drive device.

Further advantageous embodiments of the suggested invention in particular result from the features of the subclaims. The objects or features of the different claims can be basically realized individually or else be arbitrarily combined with each other.

In an advantageous embodiment of the invention, the electrical machine and a converter may be accommodated in one housing. This results in a compact design. Further components may be received in the housing, such as, for example, transmissions, output shafts etc.

In a further advantageous embodiment of the invention, the housing may comprise a converter compartment and a motor compartment, the converter being received in the converter compartment, the electrical machine being received in the motor compartment, the first connection piece being arranged in the motor compartment, and the second connection piece being arranged in the converter compartment, the connection body being arranged between the motor compartment and the converter compartment in a sealing manner. By this, for example, cooling fluid may flow around the motor compartment and in particular the winding overhang or the first connection pieces, the converter compartment and in particular the second connection pieces being sealed from the cooling fluid.

Further features and advantages of the present invention will become clear with respect to the following description of preferred exemplified embodiments with reference to the enclosed drawings. In the drawings

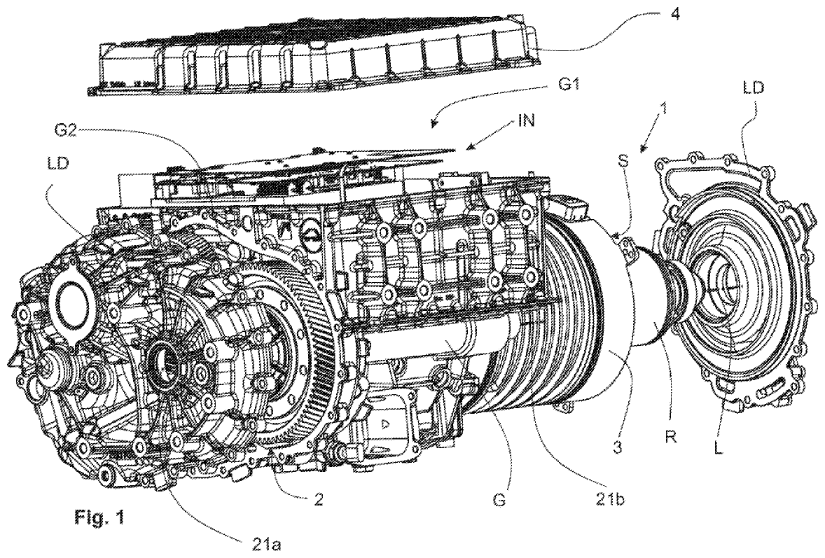

FIG. 1 shows a drive device according to the invention in a perspective (exploded) representation;

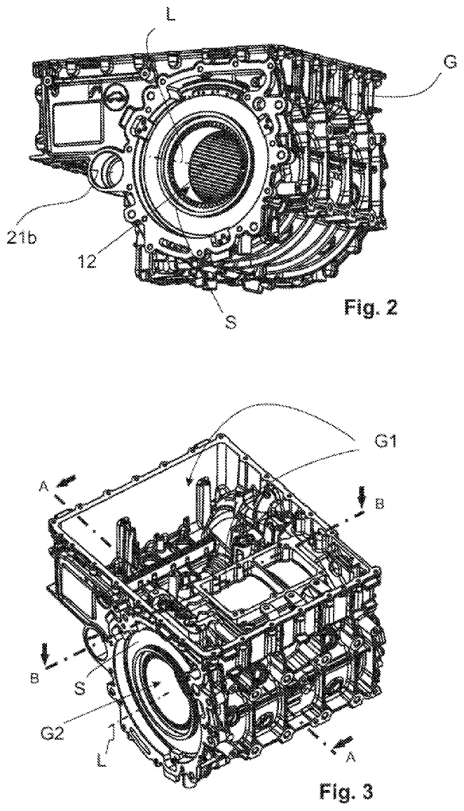

FIG. 2 shows a drive device according to the invention in a perspective representation—for illustrative purposes with some non-depicted components;

FIG. 3 shows a drive device according to the invention in a perspective representation—for illustrative purposes with some non-depicted components;

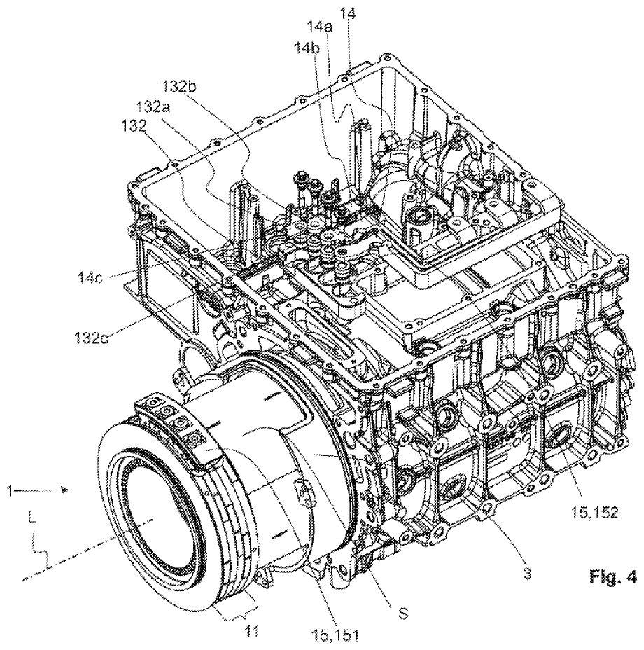

FIG. 4 shows a drive device according to the invention in a perspective exploded view—for illustrative purposes with some non-depicted components;

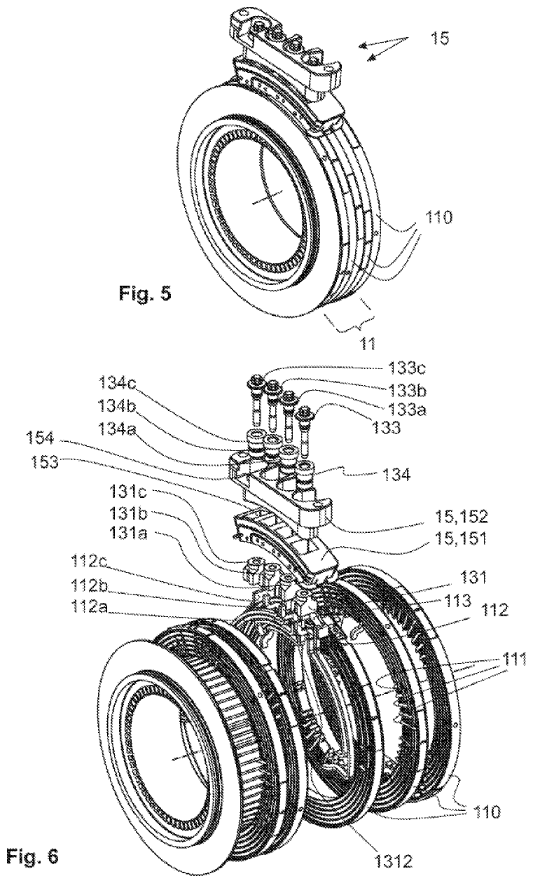

FIG. 5 shows a winding overhang with a connection device for a drive device according to the invention in a perspective representation;

FIG. 6 shows a winding overhang with a connection device for a drive device according to the invention in a perspective exploded view;

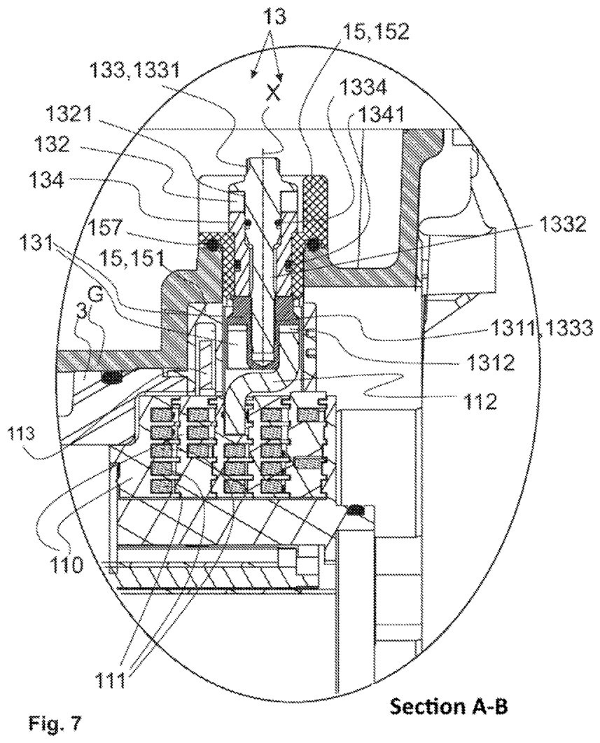

FIG. 7 shows a detailed representation of a drive device according to the invention according to A-A of FIG. 3;

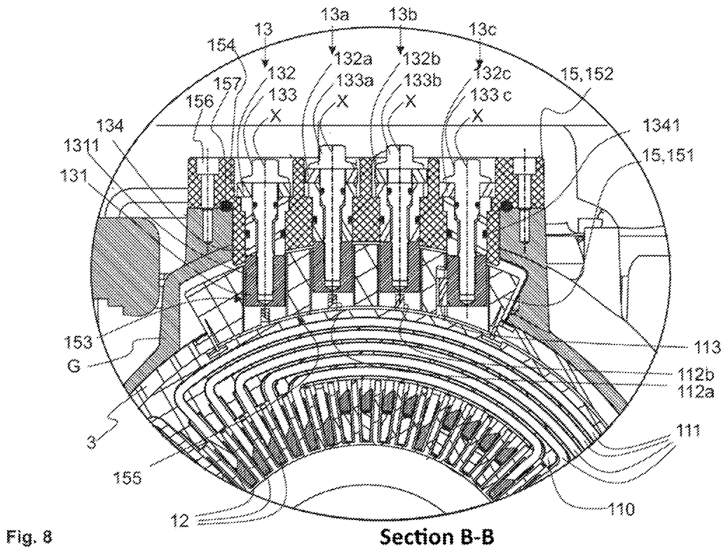

FIG. 8 shows a detailed representation of a drive device according to the invention according to B-B of FIG. 3.

The following reference numerals are used in the drawings:
L longitudinal axis (electrical machine)
LD end plate
IN converter
G housing
G1 converter compartment
G2 motor compartment
R rotor
S stator
X axis (connection pieces)
1 electrical machine, in particular electric motor
2 transmission
3 cooling housing
4 cover
11 winding overhang
12 rod conductor
13 (a-c) connection means
14 (a-c) electric conductor
15 connection body
21 (a, b) output shaft
110 insulation discs
111 interconnection lugs
112 (a-b) phase connection lug
112c star-point connection lug
113 star-point connector lug
131 (a-c) first connection piece
132 (a-c) second connection piece
133 (a-c) screw
134 (a-c) sleeve
151 first partial body
152 second partial body
153 feedthrough
151 receiving means
155 locating surface
156 connection means
157 sealing ring
1311 threaded bore
1312 welding gap
1321 bore
1331 screw head
1332 non-threaded section
1333 threaded section
1334 sealing means (O-ring)
1341 sealing means (O-ring)

A drive device according to the invention essentially comprises an electrical machine 1, in particular an electric motor, comprising a rotor R and a stator S, a transmission 2 and a converter IN.

The aforementioned components are accommodated in a common housing G and correspondingly form a compact drive device. The housing G is preferably split into two parts and comprises a converter compartment G1, and a motor compartment G2. The housing is closed by a cover 4 at the converter side. An end plate LD is attached at both sides at the motor compartment G2. An end plate at least partially encloses the transmission 2.

The transmission 2 is designed as a reduction gear with an integrated differential and has two output (half) shafts 21a,b guided out of the housing G.

The drive device is to be preferably employed as a compact drive device for a motor vehicle. Insofar, the electrical machine is preferably an electric motor. However, it is also conceivable for the electrical machine to be an electric generator, or for the electric motor to be used as a generator. Below, the term electric motor will be used synonymously for electrical machine.

The electric motor 1 essentially comprises a stator S and in particular a rotor R, wherein the rotor R is mounted rotatably about a common longitudinal axis L with respect to the stator S. The stator S comprises a built winding assembled from rod conductors 12 introduced in grooves of the stator core pack and interconnection lugs 111 electrically connecting the rod conductor ends. The interconnection lugs 111 essentially form the winding overhang 11. The interconnection lugs 111 essentially connect rod conductors 12 of the stator S according to a predetermined pattern. Preferably, the winding is a three-phase winding. Therefore, three phase connections of the phases U, V, W are guided out of the electric motor in the form of three phase connection lugs 112 to 112b. Furthermore, a star point of the winding is guided out of the electric motor via a star-point connection lug 112c. The three phases U, V, W, are electrically connected at a winding end via a star-point connector lug 113. Below, the components in question which are required by a multi-phase connection are preferably drawn in the illustrations with the corresponding indices a to c.

To connect the electric motor 1, in particular a phase connection lug 112 or 112a or 112b, or the star-point connection lug 112c, to an electric current source (or voltage source), in particular a converter, a connection means 13 to 13c and one electric conductor 14 to 14c each are provided. The electric conductor 14, 14a-c can be a rigid strip conductor, preferably of solid copper, which is firmly installed in the housing. Of course, a suited flexible cable is also conceivable.

The connection means 13, 13a-c essentially comprises a first connection piece 131, 131a-c, a second connection piece 132, 132a-c, and a screw 133, 133 a-c with a screw head 1331.

The first connection piece 131, 131 a-c is connected with the phase connection lug in question 112 or 112a or 112b, or the star-point connection lug 112c. Furthermore, the first connection piece 131, 131 a-c comprises a threaded bore 1311 for screwing-in the threaded section of the screw 133, 133 a-c. The threaded bore 1311 is provided in the embodiment as a bore with a prefabricated thread. As an alternative, a threaded bore designed as a borehole would be possible in which the thread is impressed by a self-tapping screw during the assembly operation.

The second connection piece 132, 132 a-c comprises a bore 1321. The bore 1321 is provided in the electric conductor 14. The bore 1321 can be an open or closed recess.

According to the invention, the first connection piece 131, 131 a-c may be integrally connected, in particular welded, to the phase connection lug in question 112 or 112a or 112b, or the star-point connection lug 112c, and the threaded bore 1311 of the first connection piece 131, 131 a-c and the bore 1321 of the second connection piece 132, 132 a-c may comprise a common geometric axis X.

An integral connection is preferably created by welding. However, soldering, gluing, or other integral connections are furthermore also conceivable.

The connection means 13, 13a-c can furthermore comprise a sleeve 134, 134 a-c. The second connection piece 132, 132 a-c is preferably arranged between the screw head 1331 and the sleeve 134. The sleeve 134 in turn is preferably arranged between the second connection piece 132, 132 a-c and the first connection piece 131, 131 a-c.

The screw 133, 133 a-c comprises, seen in the sequence from the screw head 1331, a non-threaded section 1332 and a threaded section 1333. Preferably, the non-threaded section 1332 is arranged in the sleeve 134 at least in sections. The non-threaded section 1332 is preferably equipped with a sealing means 1334, in particular an O-ring seal. The screw 133, 133 a-c is preferably an expansion screw.

For the preferably three phase connection lugs 112 or 112a and 112b, or the star-point connection lug 112c, preferably four connection means 13, 13a, 13b, and 13c are correspondingly combined into a connection terminal. The connection terminal comprises, apart from the connection means 13, 13a, 13b, and 13c, an insulating connection body 15.

The insulating connection body 15 can comprise feedthroughs 153 and/or receiving means 154 for the connection elements and/or locating surfaces 155 for the overhead winding contour and/or connection means 156 for the connection with the housing G.

The connection body 15 can be split into two parts, and the aforementioned functions can be distributed to the components. Thus, the connection body 15 can comprise a first partial body 151 and a second partial body 152. In particular, the connection bodies 151, 152 can be preassembled independently, so that the comparably soiling assembly operation of the electric motor and the highly clean assembly operation of the drive converter can be practically carried out separately.

The first partial body 151 facing the winding overhang 11 can comprise the feedthroughs 153 for the connection pieces 131, 131 a-c, and a locating surface 155 adapted to the winding overhang contour. The locating surface 155 can be, for example, designed as a vaulted locating surface, in particular as the winding overhang 11 is in most cases designed as an essentially circular cylinder. The feedthroughs 153 are preferably adapted to the preferably angular cross-section or the angular outer contour of the first connection pieces 131, 131 a-c and form, in the direction of rotation of fastening, a positive abutment to absorb fastening forces and moments. The electrically conductive welding of first connection pieces 131, 131 a-c with the connection lugs 112 is thereby protected from harmful power influences.

The second partial body 152 facing away from the winding overhang with respect to the first partial body 151 can comprise receiving means 154 for the connection pieces 132 or 134, respectively, and connection means 156 for the connection with the housing G. The connection means 156 can comprise, for example, fixing bores for screws through which screws can be pushed and screwed into the housing G.

Further details of the present invention in particular result from the synopsis with the connection of the electric motor 1 to the current source, in particular the converter.

The rotationally symmetric sleeves 134, 134 a-c are preferably received directly in the connection body 15, in particular the upper connection body 152, wherein the connection body 15 preferably separates the converter compartment G1 and the motor compartment G2 from each other in a sealing manner. The connection body 15 preferably comprises a circumferential sealing ring 157. The sleeve 134 preferably comprises the sealing element 1341, e.g. the O-ring, with respect to the connection body 15. The screw 133, 133 a-c of the threaded joint preferably comprises the sealing element 1334, in particular the O-ring, with respect to the sleeve 134. At the upper and bottom sides of the sleeve 134, a further sealing element in the form of a metallic or non-metallic sealing washer can be attached.

For a simple assembly, the phase connection lug 112, 112 a-b or star-point connection lug 112c of the stator winding is designed as a solid wire. The interconnection lugs 111 are combined in the winding overhang 11, preferably into an interconnection ring in which the individual interconnection lugs 111 and the connection lugs 112 are arranged in insulation discs 110 stacked upon each other in multiple layers, wherein the phase connection lug 112, 112 a-b or the star-point connection lug 112 is guided out of the interconnection ring or an insulation disc, preferably radially.

As already illustrated above, one first connection piece 131, 131 a-c each is connected, in particular welded, to an associated phase connection lug 112, 112 a-b or star-point connection lug 112c. To this end, the first connection piece 131, 131 a-c preferably comprises a welding gap 1312 in which the phase connection lug 112, 112 a-b in question or the star-point connection lug 112c is received and fixed.

The first connection piece 131, 131 a-c and the phase connection lug 112, 112 a-b in question or the star-point connection lug 112c can also be designed in one piece/integrally. Then, the attachment of a separate connection piece 131, 131 a-c is omitted.

For assembly, the interconnection ring is assembled. An interconnection ring is a winding overhang 11 assembled from interconnection lugs 111.

The winding overhang 11 or interconnection ring is cooled by oil. The phase connection lugs 112, 112 a-b or the star-point connection lug 112c project from it like fingers.

The first connection pieces 131, 131 a-c are received in the insulating connection body 15 (placed from the top), in particular the first partial body 151. The connection body 151 in particular fixes the connection pieces 131, 131 a-c and absorbs, during the fastening operation, forces acting on the connection means 13, 13 a-c, and thus protects the phase connection lug 112, 112 a-b or the star-point connection lug 112c from damages.

The first partial body 151 is pre-assembled on the interconnection ring. The essentially finished stator S is laterally inserted into the cooling housing 3 which receives it, the cooling housing 3 preferably comprising a bulging for receiving the first partial body 151, so that the connection body 151 is held by the cooling housing 3 circumferentially/on three sides. The cooling housing 3 is axially pushed into the housing G and fixed via ears. The housing G has a breakthrough. Before the stator S with the cooling sleeve 3 is inserted, the second partial body 152 with already inserted sleeves 134 will be or is screwed on the housing G via the connection means 156 in a fluid-tight manner. Upon insertion, phase outputs and the star point of the converter are screwed to the connection means 13.

The thread 1311 of the connection means 13, 13 a-c is already pre-positioned via the connection body 15, so that an all-automatic fastening is also possible. The screw 133, 133 a-c is preferably an expansion screw.

The screw 133, 133 a-c can be electrically non-conductive. The current is preferably transmitted via the respective sleeve 134.

Subsequently, the housing G can be closed by a cover 4, and end plates LD can be flanged on both sides (upon assembly of the transmission 2). The converter compartment G1 is separated from the motor compartment G2 by the connection body 15 in a fluid-tight manner. Thereby, a cooling fluid can be directly admitted to the motor-side connection means 13, 13 a-c, in particular the screws 133, 133 a-c or their screw heads 1331. This has the advantage, among other ones, that the heat introduction originating from the motor winding into the converter, which is more susceptible to failure due to temperature, is lower. In the embodiment represented in the drawings, four connections are represented, three connections representing the phases of the three-phase motor, and the fourth connection being the lead-through of the star point.

Via the star point, e.g. a charging operation can be realized wherein the motor windings act as charging inductances of a step-up switching regulator for stepping up from 400 V to 800 V. Since here, the voltage potential of the input (star point) and the output (three phases) is very high, the input and output connections are preferably attached in opposite directions. Thereby, the connections can be positioned altogether closer to one another without falling below normatively required air and leakage paths. The connection body 15 is designed such that the second connection pieces 132, 132a, 132b for the associated phase connection lugs 112, 112 a-b depart in one direction, and the second connection piece 132c for the star-point connection lug 112c departs in another direction.

Features and details described in connection with a method naturally also apply in connection with the device according to the invention, and vice versa, so that with respect to the disclosure, mutual reference is made, and can be made, to the individual aspects of the invention. Moreover, an optionally described method according to the invention can be carried out by the device according to the invention.

1. Electrical machine, in particular electric motor, comprising
a stator with a winding overhang, wherein
the winding overhang is equipped with at least one phase connection lug or star-point connection lug, wherein
a connection means is provided for the electric connection of the phase connection lug or star-point connection lug to a current source, wherein
the connection means comprises a first connection piece which is connected with the phase connection lug or the star-point connection lug and comprises a threaded bore, wherein
the connection means comprises a second connection piece which is equipped with a bore,
wherein
the first connection piece is integrally connected, in particular welded, to the phase connection lug in question or the star-point connection lug, and the threaded bore of the first connection piece and the bore of the second connection piece comprise a common geometric axis, wherein a screw is screwed through the bore of the second connection piece into the threaded bore of the first connection piece.

2. Electrical machine according to claim 1, wherein a sleeve is provided between the first connection piece and the second connection piece, wherein the sleeve is electrically connected both to the first connection piece and the second connection piece.

3. Electrical machine according to claim 1, wherein the second connection piece comprises a rigid electric conductor in which the bore is introduced.

4. Electrical machine according to claim 1, wherein an insulating connection body for the connection means is provided, wherein the connection means is received in the connection body at least in sections.

5. Electrical machine according to claim 1, wherein the first connection piece has an angular cross-section, wherein a seat in the connection body, in particular the first partial body, for the first connection piece has an angular design.

6. Electrical machine according to claim 1, wherein the electrical machine is equipped with four connection means which are received in the connection body at least in sections.

7. Electrical machine according to claim 1, wherein the screw is equipped with a sealing means, in particular an O-ring.

8. Electrical machine according to claim 1, wherein the sleeve is equipped with a sealing means, in particular an O-ring, preferably on its outer side.

9. Electrical machine according to claim 1, wherein the threaded bore is provided as a prefabricated threaded bore or as a threaded bore created during the fastening of a self-tapping screw, in particular a chiplessly self-tapping screw.

10. Electrical machine according to claim 1, wherein the screw has a self-locking design, in particular by a variable thread lead.

11. Electrical machine according to claim 1, wherein the connection piece is made of copper or aluminum or a copper or aluminum alloy, respectively.

12. Electrical machine according to claim 1, wherein the electric conductor and/or the connection piece and/or the phase connection lug and/or the star-point connection lug is designed as a solid wire, for example as a copper rod.

13. Drive device, preferably for a motor vehicle, comprising a housing in which an electrical machine, in particular an electric motor, is received, wherein the electrical machine according to claim 1.

14. Drive device according to claim 13, wherein the electrical machine and a converter are accommodated in the housing.

15. Drive device according to claim 13, wherein the housing comprises a converter compartment and a motor compartment, wherein the converter is received in the converter compartment, wherein the electrical machine is received in the motor compartment, wherein the first connection piece is arranged in the motor compartment, and the second connection piece is arranged in the converter compartment, wherein the connection body is arranged between the motor compartment and the converter compartment in a sealing manner.

16. Electrical machine according to claim 2, wherein the second connection piece comprises a rigid electric conductor in which the bore is introduced.

17. Electrical machine according to claim 16, wherein an insulating connection body for the connection means is provided, wherein the connection means is received in the connection body at least in sections.

18. Electrical machine according to claim 17, wherein the first connection piece has an angular cross-section, wherein a seat in the connection body, in particular the first partial body, for the first connection piece has an angular design.

19. Electrical machine according to claim 18, wherein the electrical machine is equipped with four connection means which are received in the connection body at least in sections.

20. Electrical machine according to claim 19, wherein the screw is equipped with a sealing means, in particular an O-ring.
